(19) United States
(12) Patent Application Publication
(10) Pub. No.: US 2016/0282115 A1
(43) Pub. Date: Sep. 29, 2016

(54) ULTRASONIC LOW FRICTION COMPASS

(71) Applicant: Floyd L Wilson, Manhattan, KS (US)

(72) Inventor: Floyd L Wilson, Manhattan, KS (US)

(21) Appl. No.: 14/527,120

(22) Filed: Oct. 29, 2014

(51) Int. Cl. G01C 17/04

(52) U.S. Cl. CPC G01C 17/04

(57) ABSTRACT

The direction determination device includes a magnetized pointer having an indentation surface; a stationary housing; an elongated pivot located centrally near a top of the stationary housing and having a tapered end and a central axis, the tapered end engaging a indentation surface; a motor mechanism mounted within the housing and attached to the elongated pivot; and a power source selectively coupled to the motor mechanism to cause movement of the pivot relative to the housing in such as manner so as to create a near frictionless contact between the pivot tapered end and the indentation surface of the magnetized pointer.

### BACKGROUND OF THE INVENTION

Navigational instruments find use in a wide range of applications such as personal or vehicular navigation and mapping systems, missile guidance systems, target location systems, ships and other vessel's compass systems, aviation, and the like. Examples of navigational instruments are an electronic compass, magnetometer, or magnetic compass, such as a gyro-compass. Magnetic compasses have been used by navigators for centuries, relying on the Earth's magnetic field to align a magnetized pivotable needle with the Earth's field to point to (magnetic) north.

A magnetic compass capable of measuring the azimuth of a line of magnetic force generated by an external magnetic field such as earth magnetism is widely used as a means for detecting the position of a vehicle, such as a vehicle-mounted compass and navigation system. Such a magnetic compass is a device capable of detecting magnetism in two directions such as the X and Y directions orthogonal to each other on a plane using a magnetic sensor such as a flux gate, a Hall element, a giant magnetic reluctance element, or an magnetic impedance element. The horizontal component of the earth magnetism is detected by sensors of the X and Y axes to thus calculate the direction of the magnetic north from the magnitude of the detected horizontal component.

A problem with these compass systems is effectively determining the direction of True North in a way that is sufficiently compact, accurate, and cost effective enough to be deployed in common applications such as navigation or target location equipment in vehicle and portable contexts. Another problem with magnetic compass devices is friction between a pointer or needle and the structure on which it is mounted can cause inaccuracies in the indicated direction.

### SUMMARY OF THE INVENTION

The present invention provides a direction determination device utilizing a motor to cause oscillations of a pivot on a compass or compass apparatus, so as to create a near frictionless or low friction engagement with a compass needle.

An embodiment of a low friction bearing apparatus comprising: a first structure; a second structure bearing against the first structure and movable relative thereto; and a vibration mechanism engaged with the first structure to vibrate the first structure to thereby cause the second structure to be periodically disengaged from the first structure to thereby reduce friction between the second structure and the first structure.

It is foreseen in another embodiment, wherein: the second structure is rotatably mounted on the first structure. It is also foreseen, that the second structure is mounted upon the first structure and is supported thereby.

An embodiment of a low friction bearing apparatus comprising: a compass base; a pivot pin upstanding from the compass base; a direction indicator balanced on the pivot pin and rotatably bearing thereupon, the indicator having opposite magnetic poles at diametric positions thereof whereby the direction indicator tends to align with the geomagnetic field; and a vibration mechanism engaged with the compass base in such a manner as to vibrate the pivot pin to thereby cause the direction indicator to be periodically disengaged from the pivot pin to thereby reduce friction between the direction indicator and the pivot pin to thereby increase an accuracy of the compass apparatus.

It is foreseen in another embodiment, wherein: the shoulder engages the compass base such that the shoulder is vibrated by the vibration mechanism.

It is foreseen in another embodiment, wherein the apparatus further comprises a compass rose positioned in relation to the indicator to facilitate directional determination by the compass apparatus.

It is foreseen in another embodiment, wherein: the direction indicator is an elongated compass needle with the opposite magnetic poles positioned at opposite ends of the needle.

In another embodiment of the direction determination device includes a magnetized pointer having an indentation surface; a stationary housing; an elongated pivot located centrally near a top of the stationary housing and having a tapered end and a central axis, the tapered end engaging the spherical indentation surface; a motor mechanism mounted within the housing and attached to the elongated pivot; and a power source selectively coupled to the motor mechanism to cause movement of the pivot relative to the housing in such as manner so as to create a near frictionless contact between the pivot tapered end and the indentation surface of the magnetized pointer.

The device may also include shoulder surrounding the pivot, so as to keep the pointer at one plane.

A light source, such as a light emitting diode (LED), may be positioned within the housing to radiate light through when the motor mechanism is activated. The housing may have a power source mounted therein for powering the motor mechanism and the light source. The power source may, for example, be a battery. The housing may have a switch, such as a push-button toggle switch or the like, to enable selective activation of the motor mechanism and the light source.

The motor mechanism can be a small conventional rotary electric motor which oscillates and rotates the pivot with respect to the central axis at higher frequencies, this oscillation creates a low friction contact between the pivot and the needle. Alternatively, the motor mechanism may cause a reciprocating motion so that the pivot moves in an up and down manner along the central axis. It is also foreseen that the motor mechanism could have capabilities for a combination of oscillatory and reciprocating motions of the pivot.

In an embodiment of the compass apparatus, the motor mechanism is a type of ultrasonic motor mechanism in which piezoelectric elements vibrate at ultrasonic frequencies to cause the pivot to vibrate in such a manner as to cause combined reciprocating and oscillatory motions. The ultrasonic motor mechanism may, for example, be of the type which are employed in ultrasonic toothbrushes.

The indentation surface where the pivot meets with the compass needle, may be of various shapes and sizes, i.e. cubic, conical, spherical, or trapezoidal. These shapes create a contact point between the pivot and indentation surface. When the pivot is vibrated at ultrasonic frequencies, the friction at the contact point is reduced, and the energy needed to move the needle is thus, reduced. This enables the needle to more readily detect a magnetic field, such as the geomagnetic field or the Earth's magnetic field, which can be measured in the pico-Tesla (10e-8 Oe) range.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTION OF THE DRAWINGS

FIG. 1 is a perspective view of an ultrasonically powered low friction direction determination device according to the present invention.

FIG. 2 is a cross-section taken along line 2-2 of an ultrasonically powered low friction direction determination device according to the present invention.

FIG. 3 is a perspective view of an alternative embodiment of an ultrasonically powered low friction direction determination device further including a shoulder according to the present invention.

FIG. 4 is a cross-section taken along line 3-3 of an ultrasonically powered low friction direction determination device according to the present invention.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Referring to the drawings in more detail, the reference numeral 1 generally designates a direction determining device according to the present invention. The device 1 generally includes a housing 2 with an outer section 4 supporting an inner section 8 that holds a pivot 8 centrally along an axis A. The housing 2 has a motor mechanism 10 enclosed therein which is activated to cause movement of the pivot 8 relative to the housing 2.

The illustrated housing 2 is of a cylindrical shape, although other shapes are foreseen. The housing 2 has a hollow chamber 9 that provides space to receive the motor mechanism 10 (FIG. 2). Additionally seen in FIG. 2, an electrical power source 12 for powering the motor mechanism 10, such as a battery, may be mounted within the chamber 9. The housing 2 may also be provided with a switch mechanism (not shown) for selectively applying electrical power from the battery 12 to the motor mechanism 10.

The device 1 may include a light source (not shown) which is positioned within the housing 2 and which is activated by the power source 12 when the motor mechanism 10 is activated, by operation of a switch (not shown). The light source may, for example, be one or more light emitting diodes (LEDs).

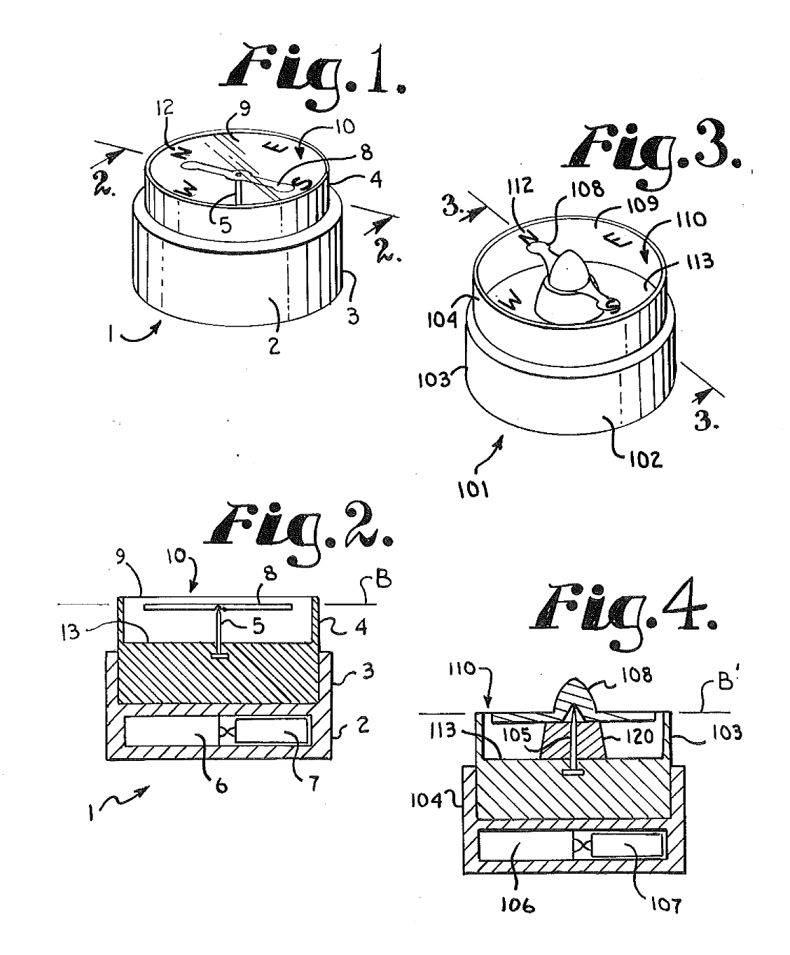

Referring now to FIG. 1, an orienteering type of compass is shown comprising of three main parts: a magnetic direction indicator, such as a needle 14, a disc (not shown), or the like, traversely situated along a plane B, the housing 2 with a transparent cover 16, and the pivot 8. The cover 16 is marked with a compass rose showing the four cardinal points of north, east, south, and west and it is foreseen that the compass rose may be further divided into smaller degree graduations indicating the full 360 degrees of a circle. The four cardinal points are all 90 degrees apart, with East being at 90 degrees, South at 180 degrees, West at 270 degrees, and North at 360 degrees (or zero degrees). It is foreseen that the cover 16 may be fastened onto the housing with screws to close the top opening 18 of the housing 2. It is foreseen that the cover 16 may be a biconvex lens. It is also foreseen that the magnetic needle's or disc's north end 20 is visually distinguished from the south pole end 22, such as being colored red.

It is foreseen that a cover 16 of the housing 2 can be marked with an orienting arrow (not shown) and meridian lines (not shown).

In one embodiment of the direction determining device 1, the motor mechanism 10 is a type of ultrasonic motor mechanism. Such an ultrasonic motor mechanism 10 may be similar in construction and operation to those disclosed in U.S. Pat. Nos. 4,697,117 and 5,051,647, the disclosures of which are incorporated herein by reference. Motion from the ultrasonic motor mechanism 10 may have rotational components, and/or reciprocating motion components. The motion components of the ultrasonic motor mechanism 10 are transmitted to the magnetized needle 14 through the pivot 8. Such motion components cause a low friction or nearly frictionless contact between the pivot 8 and the needle 14 at a contact point between the pivot 8 and a indentation surface. The low friction contact allows for accurate alignment with a small magnetic field, as the turning of the needle 14 with respect to the pivot 8 does not have to overcome a large friction coefficient, thus requiring less energy to make the needle move.

The effect of the motor mechanism 10 on the pivot 8 is similar to a so called acoustic levitation or acoustophoresis, in which the vibration of the pivot 8 periodically disengages the needle 14 from the pivot 8 or reduces the bearing force therebetween, whereby the needle 14 can move toward alignment with the geomagnetic force with less frictional contact with the pivot 8.

It is also foreseen that the motor mechanism 10 may be a more conventional electromagnetic type of motor mechanism which may incorporate rotary and/or reciprocating motion components.

Magnetic needles 14 are affected by the horizontal and vertical pull direction of the Earth's magnetic field. The closer one is located to the magnetic north pole (located near Bathurst Island in Northern Canada in 2007), the more the north-seeking end of the needle 14 is pulled downward. Whereas, at the south magnetic pole (located just off the coast of Wilkes Land, Antarctica in 2007) the north-seeking end of the needle 14 is deflected upward. Only at the equator is the needle 14 unaffected by vertical magnetic forces that will point the magnetized needle 14 off the plane B.

Referring now to FIG. 3, the reference numeral 101 generally designates a motorized direction determining device according to a second embodiment. FIG. 3 shows an orienteering type of compass typically comprising of four main parts: a magnetic needle 114 situated along a plane B′, a housing 102 with a transparent cover 116, a pivot 108, and a shoulder 130. The cover 116 is marked with a compass rose showing the four cardinal points of north, east, south, and west and it is foreseen the compass rose may be further divided into smaller degree graduations indicating the full 360 degrees of a circle. The four cardinal points are all 90 degrees apart, as disclosed previously. It is foreseen that the cover 116 may be fastened onto the housing with screws to close the top opening 118 of the housing 102. It is foreseen that the cover 116 may be a biconvex lens. It is also foreseen that the magnetic needles north end 112 is painted red.

The device 101 generally includes a housing 102 with an outer section 104 supporting an inner section 106 that holds a pivot 108 centrally along an axis A. The housing 102 has a motor mechanism 110 enclosed therein which is activated to cause movement of the pivot 108 relative to the housing 102. The shoulder 130 is used to compensate for upward and downward shifts or declination of the needle 108, by forcing the needle to remain parallel with plane B′. The illustrated shoulder 130 completely surrounds the pivot 108, and it is foreseen to be at a height that engages the magnetic needle 114 or at a height near to the magnetic needle 114.

Referring to FIG. 4, the illustrated housing 102 is of a cylindrical shape, although other shapes are foreseen. The housing 102 has a hollow chamber 109 that provides space to receive the motor mechanism 110 (FIG. 4). Additionally seen in FIG. 4, an electrical power source 112 for powering the motor mechanism 110, such as a battery, may be mounted within the chamber 109. The housing 102 may also be provided with a switch mechanism (not shown) for selectively applying electrical power from the battery 112 to the motor mechanism 110.

The direction determination device 101 may include a light source (not shown) which is positioned within the housing 102 and which is activated by the power source 112 when the motor mechanism 110 is activated, by operation of the switch mechanism (not shown). The light source may, for example, be one or more light emitting diodes (LEDs).

The motor mechanism 110 is very similar to the previous motor mechanism 10, and may be a type of ultrasonic motor mechanism. Motion from the ultrasonic motor mechanism 110 may have rotational components, and/or reciprocating motion components. The motion components of the ultrasonic motor mechanism 110 are transmitted to the magnetized needle 114 through the pivot 108. Such motion components cause a low friction or nearly frictionless contact between the pivot 108 and the needle 114 at a contact point between the pivot 108 and a indentation surface. The low friction contact allows for easier alignment of the needle 114 with a geomagnetic field, as the turning of the needle 114 with respect to the pivot 108 does not have to overcome a large friction coefficient, thus requiring less energy to make the needle move.

It is also foreseen that the motor mechanism 110 may be a more conventional electromagnetic type of motor mechanism which may incorporate oscillatory and/or reciprocating motion components.

It is to be understood that while certain forms of the present invention have been illustrated and described herein, it is not to be limited to the specific forms or arrangement of parts described and shown.

What is claimed and desired to be secured by Letters Patent is as follows:

1. A low friction bearing apparatus comprising:
(a) a first structure;
(b) a second structure bearing against the first structure and movable relative thereto; and
(c) a vibration mechanism engaged with the first structure to vibrate the first structure to thereby cause the second structure to be periodically disengaged from the first structure to thereby reduce friction between the second structure and the first structure.

2. An apparatus as set forth in claim 1 wherein:
(a) the second structure is rotatably mounted on the first structure.

3. An apparatus as set forth in claim 1 wherein:
(a) the second structure is mounted upon the first structure and is supported thereby.

4. An apparatus as set forth in claim 1 wherein:
(a) the vibration mechanism is an ultrasonic vibration mechanism.

5. A low friction magnetic compass apparatus comprising:
(a) a compass base;
(b) a pivot pin upstanding from the compass base;
(c) a direction indicator balanced on the pivot pin and rotatably bearing thereupon, the indicator having opposite magnetic poles at diametric positions thereof whereby the direction indicator tends to align with the geomagnetic field; and
(d) a vibration mechanism engaged with the compass base in such a manner as to vibrate the pivot pin to thereby cause the direction indicator to be periodically disengaged from the pivot pin to thereby reduce friction between the direction indicator and the pivot pin to thereby increase an accuracy of the compass apparatus.

6. An apparatus as set forth in claim 5 and including:
(a) a shoulder positioned about the pivot pin to further support the indicator.

7. An apparatus as set forth in claim 6 wherein:
(a) the shoulder engages the compass base such that the shoulder is vibrated by the vibration mechanism.

8. An apparatus as set forth in claim 5 wherein:
(a) the vibration mechanism is an ultrasonic vibration mechanism.

9. An apparatus as set forth in claim 5 and including:
(a) a compass rose positioned in relation to the indicator to facilitate directional determination by the compass apparatus.

10. An apparatus as set forth in claim 5 wherein:
(a) the direction indicator is an elongated compass needle with the opposite magnetic poles positioned at opposite ends of the needle.

11. A device as set forth in claim 5, wherein: the pivot pin is moved in a direction along a central axis.

12. A device as set forth in claim 5, wherein: the pivot pin is moved in a direction traverse to a central axis.
